(19) United States
(12) Patent Application Publication
(10) Pub. No.: US 2019/0191303 A1
(43) Pub. Date: Jun. 20, 2019

(54) Deployable Cell And Method For Validating A Deployable Cell To Be Fully Operational

(71) Applicant: MOTOROLA SOLUTIONS, INC, Chicago, IL (US)

(72) Inventors: GABI OFIR, RESHON LETZION (IL); ALEXANDER MASSOVER, BATHEFER (IL); GUY HOLTZMAN, TEL AVIV (IL); DANNY ZADOK, RESHON LETZION (IL)

(21) Appl. No.: 15/846,249

(22) Filed: Dec. 19, 2017

(51) Int. Cl. H04W 12/06; H04L 29/06; H04W 48/02

(52) U.S. Cl. CPC H04W 12/06; H04W 16/24; H04W 48/02; H04L 63/083

(57) ABSTRACT

A method and deployable cell are provided that validate a deployable cell to be fully operational. Upon powering up, the deployable cell is established as operational in a restricted mode. When an attach request is received from a mobile device at the deployable cell, the deployable cell determines if the mobile device making the attachment request is a supervising device. If so, the operational status of the deployable cell is changed from restricted mode with limited capabilities to fully operational mode.

### BACKGROUND OF THE INVENTION

Portable communication systems, such as vehicular ad hoc networks, are effective in providing mobile cellular and private mobile network services. As these systems are portable, they are vulnerable to theft or unauthorized physical access. This could lead to the eventual risk of compromising security keys stored in memory of the portable communication systems. In current solutions, all SIM cards need to be replaced in all mobile devices that can use the portable communication system in order to overcome the potential compromising of the secret keys on each of the mobile device's SIM cards.

A further problem with a stolen or compromised portable communication system is that unauthorized use of such a system could interfere with other deployed systems.

An additional problem with a stolen portable communication system is that, without some mechanism to stop operation, the system can be used by the thieving parties. Stolen deployable communication systems should somehow be disabled so that they are not operational if stolen.

Therefore, a need exists for a method of securing a deployable cell so that it is fully operational when desired while not operational when stolen.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 depicts a system diagram of a portion of a communication system in accordance with an exemplary embodiment of the present invention.

FIG. 2 depicts a flow chart in accordance with an exemplary embodiment of the present invention.

FIG. 3 depicts a call flow diagram in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

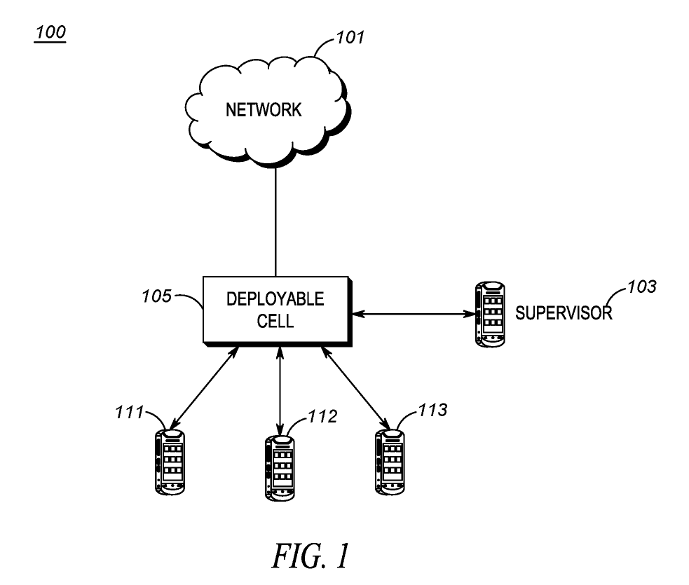

FIG. 1 depicts a system diagram of a portion 100 of a communication system in accordance with an exemplary embodiment of the present invention. In accordance with an exemplary embodiment, portion 100 of the communication system includes network 101, supervisor 103, deployable cell 105, and regular subscribers 111, 112, and 113. It should be understood that there can be a plurality of deployable cells, subscribers, and supervisors in portion 100, but only the above elements are shown for purposes of clarity.

Network 101 is a cellular or mobile network and also preferably includes links to the public switched telephone network (PSTN). Network 101 provides for communication between users on the same or different networks.

Deployable cell 105 is a mobile, cellular base station that allows subscribers, such as public safety personnel, to connect to and utilize a cellular and telephone network. Deployable cell 105 preferably provides access to voice data, video, text, and other communication services.

In accordance with an exemplary embodiment, deployable cell 105 includes two modes of operation for subscribers. A first mode of operation is full operational mode, and a second mode of operation is restricted network node. In full operational mode, full network service is provided for subscribers to the network. For example, if the network is an LTE network, in full operational mode maximum LTE coverage is provided.

In an exemplary embodiment, restricted network mode is the mode of operation upon powering on deployable cell 105. In restricted network mode the coverage area is restricted, preferably to tens of meters. This can be accomplished using low RF transmission power or other low power techniques, such as, Wi-Fi or Bluetooth. In restricted network mode, limited network services are provided, preferably only authentication of supervisors.

Supervisor 103 is a mobile device, such as a cell phone, a land mobile radio, or any other portable mobile device that can communicate with deployable cell 105. In accordance with an exemplary embodiment, supervisor 103 is a subscriber that is equipped to enable deployable cell 105 to switch from restricted network mode to full operational mode. In accordance with an exemplary embodiment, there are a limited number of supervisors within communication system 100.

Subscribers 111, 112, and 113 are mobile devices, such as cell phones, land mobile radios, or any other portable mobile device that can communicate with deployable cell 105. In accordance with an exemplary embodiment, subscribers 111, 112, and 113 are able to receive and utilize network services via deployable cell 105, but are not able to approve deployable cell 105 to operate in full operational mode.

In the exemplary embodiment depicted in FIG. 1, mobile device 103 is depicted as a supervisor and mobile devices 111, 112, and 113 are depicted as regular subscribers. Deployable cell 105 preferably identifies mobile device 103 as a supervisor by checking a database in deployable cell 105 where supervisor IMSIs are stored. Deployable cell 105 preferably identifies mobile devices 111, 112, and 113 as subscribers by checking the IMSI database in deployable cell 105 and recognizing that mobile devices 111, 112, and 113 are not indicated in the supervisor group.

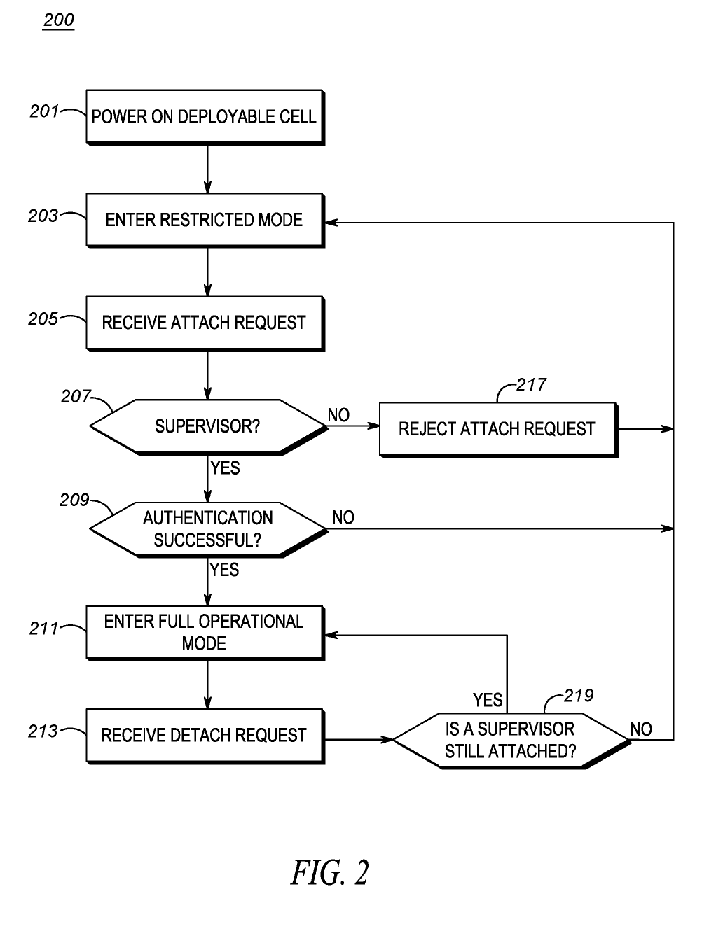

FIG. 2 depicts a flow chart 200 in accordance with an exemplary embodiment of the present invention.

Deployable cell 105 powers on (201). In accordance with an exemplary embodiment, deployable cell 105 is provided power upon arriving at an incident scene.

Upon powering on, deployable cell 105 enters (203) a restricted mode. Restricted mode provides limited network services, for example authentication by a supervisor such as mobile device 103. In accordance with an exemplary embodiment, the transmission power of deployable cell 203 is lowered when in restricted mode. By powering up in restricted mode, only supervisor mobile units can authorize deployable cell 105 to operate in full operational mode. This feature prevents a stolen deployable base station from becoming useful unless the thieves have access to a supervisor mobile device. Without a supervisor mobile device, the stolen deployable cell is limited to very short range communications and rejects any subscribers from attaching to the stolen deployable cell or accessing any wireless services.

At some point, deployable cell 105 receives (205) an attach request from a mobile device. The attach request is preferably received from a nearby mobile device, since deployable cell 105 is in restricted mode and therefore is limited to short range communications.

Deployable cell 105 determines (207) if the attach request is from a supervisor. In an exemplary embodiment, deployable cell 105 accomplishes this by checking if a subscriber ID, such as the IMSI, of the sending mobile device is located in a supervisor database located within deployable cell 105. If the subscriber ID is in the supervisor database, the sending mobile unit is considered to be a supervisor.

If the request is not from a supervisor, deployable cell 105 rejects (217) the attach request. The process then returns to step 203 and remains in restricted mode.

If the attach request is from a supervisor as determined at step 207, deployable cell 105 determines (209) if authentication of the mobile device is successful. If the authentication is not successful, the process returns to step 203 and remains in restricted mode.

The supervisor mobile device is checked at this step to not only ensure that the supervisor bit is checked, but that it has the proper keys to be an actual supervisor. In accordance with an exemplary embodiment, supervisor mobile devices are authenticated using a combination of two factors, key-based authentication and close proximity to deployable cell 105.

The key-based authentication is preferably a shared secret authentication scheme. In this type of authentication, a part of the key is stored in the network and a second part of the key is stored in supervisor mobile devices. In this manner, by splitting the keys of subscriber mobile devices between the system and supervising mobile devices, in the absence of a supervisor mobile device, subscriber mobile devices cannot attach to the system as the system does not have a full key to validate the subscriber mobile devices. A challenging method is used where hashes of the keys are compared.

If the authentication was successful as determined at step 209, deployable cell 105 enters (211) full operational mode. In full operational mode, subscribers 111, 112, and 113 are able to attach to deployable cell 105 and utilize the network for communications. In addition, the transmission power of deployable cell 105 is preferably increased when in full operational mode.

At some point, deployable cell 105 receives (213) a detach request from supervisor mobile device 103. This typically happens when mobile device 103 moves out of range of deployable cell 105.

In this exemplary embodiment, since supervisor 103 was providing authentication of deployable cell 105, deployable cell 105 determines (219) if a supervisor is still attached to deployable cell 105. If there are no supervisors attached to deployable cell 105, deployable cell 105 returns to step 203 and once again enters restricted mode. In this mode, communication resources are not available to subscriber mobile devices 111, 112, ad 113.

If it is determined at step 219 that there is still a supervisor attached to deployable cell 105, deployable cell 105 returns to step 211 and continues operating in full operational mode.

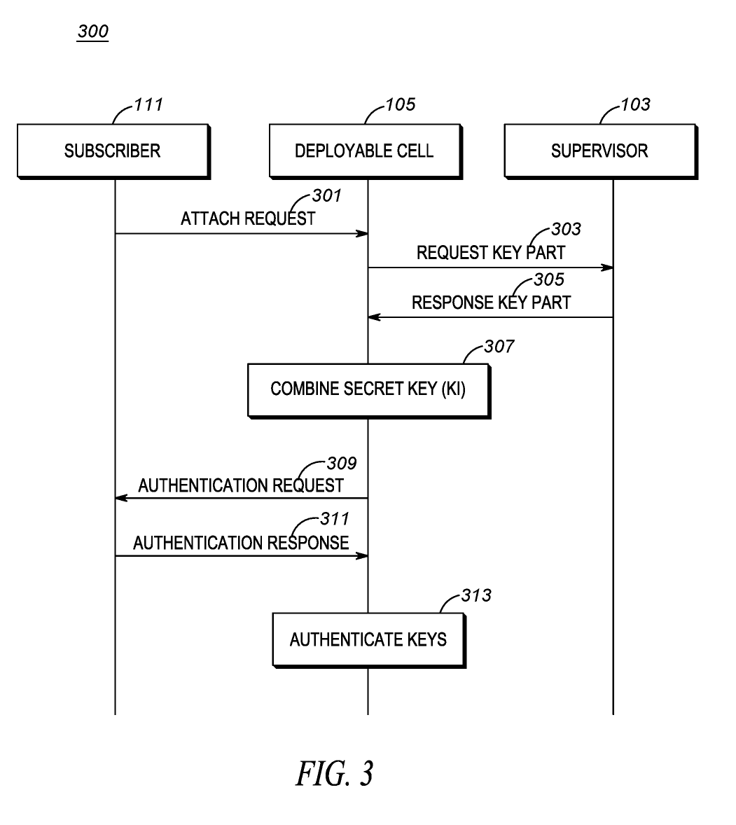

FIG. 3 depicts a call flow diagram 300 in accordance with an exemplary embodiment of the present invention. FIG. 3 depicts the call flow for a subscriber unit, such as any of the subscriber units 111, 112, or 113, attempting to connect to deployable cell 105. FIG. 3 depicts subscriber unit 111 attempting to attach to deployment cell 105.

In accordance with an exemplary embodiment, subscriber 111 sends Attach Request 301 to deployable cell 105. Attach Request 301 is a request to connect to deployable cell 05 in order to utilize the services of deployable cell 105 and communication system 100.

Upon receiving Attach Request 301 from subscriber 111, deployable cell 105 will request the shared secret part from the attached supervisor 103. In order to verify that subscriber 111 should be able to use communication system 100, deployable cell 105 sends Request Key Part message 303 to supervisor 103. Request Key Part message 303 includes a request for a part of the shared secret key (Ki) stored on supervisor 103.

After verifying that it should send its part of the key, supervisor 103 sends Response Key Part message 305 to deployable cell 105. Response Key Part message 305 includes the part of the Ki stored on Supervisor 103.

Deployable cell 105 cryptographically combines (307) the part of the Ki received in Response Key Part message 305 with a part of the Ki provisioned in a Home Subscriber Server (HSS) to form a shared secret key. In accordance with an exemplary embodiment, only combining both parts together cryptographically results in the same shared secret key provisioned in the SIM card of subscriber 111.

Deployable cell 105 sends Authentication Response message 309 to subscriber 111. Authentication Response message 309 is a request to subscriber 111 to provide a hash of a secret key stored on subscriber 111.

Subscriber 111 sends Authentication Response message 311 to deployable cell 105. Authentication Response message 311 preferably includes a hash of the secret key stored on subscriber 111.

Deployable cell 105 authenticates (313) the keys in any acceptable manner. For example, a challenge method can be used to compare hashes of the two keys. If the keys do not authenticate, subscriber 111 is denied access to deployable cell 105.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for validating a deployable cell to be fully operational, the method comprising:
establishing a deployable cell as operational in a restricted mode;
receiving an attach request at the deployable cell from a mobile device;
determining if the mobile device is a supervising device;
if the mobile device is a supervising device, operating the deployable cell in a fully operational manner; and
if the mobile device is not a supervising device, operating the deployable cell in the restricted mode.

2. The method of claim 1, the method further comprising the step of determining when the supervising device has detached from the deployable cell.

3. The method of claim 2, the method further comprising the step of determining if there is a second supervising device attached to the deployable cell.

4. The method of claim 3, wherein the deployable cell continues to operate in the fully operational manner if the second supervising device is attached to the deployable cell.

5. The method of claim 3, wherein the deployable cell reverts to restricted mode if there is no second supervising device attached to the deployable cell.

6. (canceled)

7. The method of claim 1, wherein the step of determining if the attach request is from a supervising device comprises:
receiving a shared key from the mobile device;
combining the shared key with a shared secret key at the deployable cell to form a system key; and
using the system key for authentication of the mobile device.

8. The method of claim 1, wherein the step of determining if the attach request is from a supervising device comprises utilizing the proximity of the mobile device to the deployable cell.

9. The method of claim 8, wherein the proximity of the mobile device to the deployable cell is determined utilizing the transmit power of the deployable cell.

10. The method of claim 1, wherein the step of establishing a deployable cell as operational in a restricted mode comprises establishing a deployable cell as operational in a restricted mode that provides limited network services.

11. A deployable cell comprising a processor configured to:
establish operation in a restricted mode;
receive an attach request from a mobile device;
determine if the mobile device is a supervising device;
if the mobile device is a supervising device, operate the deployable cell in a fully operational manner; and
if the mobile device is not a supervising device, operate the deployable cell in the restricted mode

12. The deployable cell of claim 11, the processor further configured to determine if the supervising device has detached from the deployable cell.

13. The deployable cell of claim 12, the processor further configured to determine if there is a second supervising device attached to the deployable cell.

14. The deployable cell of claim 13, wherein the processor is further configured to continue to operate in the fully operational manner if the second supervising device is attached to the deployable cell.

15. The deployable cell of claim 13, wherein the processor is further configured to revert to restricted mode if there is no second supervising device attached to the deployable cell.

16. The deployable cell of claim 11, wherein the processor is configured to reject the attach request if the mobile device is not a supervising device.

17. The deployable cell of claim 11, wherein the processor is configured to, when determining if the attach request is from a supervising device:
receive a shared key from the mobile device;
combine the shared key with a shared secret key to form a system key; and
use the system key for authentication of the mobile device.

18. The deployable cell of claim 11, wherein the processor is configured to utilize the proximity of the mobile device to the deployable cell when determining if the attach request is from a supervising device.

19. The deployable cell of claim 18, wherein the processor is configured to utilize the transmit power of the deployable cell when determining the proximity of the mobile device to the deployable cell.

20. The deployable cell of claim 11, wherein the processor is configured to establish a deployable cell as operational in a restricted mode that provides limited network services when establishing a deployable cell as operational in a restricted mode.
